(19) United States
(12) Patent Application Publication
(10) Pub. No.: US 2002/0077372 A1
(43) Pub. Date: Jun. 20, 2002

(54) PROCESS FOR THE PREPARATION OF O/W OR O/W/O EMULSIONS AND 0/W AND O/W/O EMULSIONS OBTAINABLE BY SUCH PROCESSES

(76) Inventors: HEINRICH GERS-BARLAG, KUMMERFELD (DE); ANJA MULLER, HAMBURG (DE); SVEN GOHLA, HAMBURG (DE); JENS NIELSON, HENSTEDT (DE)

Correspondence Address: NORRIS,McLAUGHIN & MARCUS, P.A., 220 East 42nd Street, 30th Floor, New York, NY, 10017, US

(21) Appl. No.: 08/764,954

(22) Filed: Dec. 13, 1996

(30) Foreign Application Priority Data
Dec. 21, 1995 (DE) 19548013.9

(51) Int. Cl. C09K 3/00

(52) U.S. Cl. 516/98

(57) ABSTRACT

O/W emulsions, in particular O/W microemulsions, or O/W/O emulsions or O/W/O′ emulsions comprising at least one emulsifier (emulsifier A) chosen from the group of emulsifiers having the following properties

their lipophilicity either depends on the pH such that the lipophilicity is increased or decreased by raising or lowering the pH, it being unimportant which of the two possible changes in lipophilicity is effected by increasing or lowering the pH, and/or

their lipophilicity depends on the temperature such that the lipophilicity increases with increasing temperature and their hydrophilicity increases with decreasing temperature.

The present invention relates to stable emulsions of the O/W or O/W/O or O/W/O′-type, processes for their preparation and their use for cosmetic and medicinal purposes.

Cosmetic skin care is primarily to be understood as meaning that the natural function of the skin as a barrier against environmental influences (for example dirt, chemicals, microorganisms) and against the loss of endogenous substances (for example water, natural fats, electrolytes) is intensified or re-established.

If this function is impaired, increased absorption of toxic or allergenic substances or attack by microorganisms and, as a result, toxic or allergic skin reactions may occur.

One aim of skin care is furthermore to compensate the loss of fats and water from the skin due to daily washing. This is important precisely if the natural capacity for regeneration is not adequate. Skin care products should furthermore protect against environmental influences, in particular against sun and wind, and delay ageing of the skin.

Medicinal topical formulations as a rule comprise medicaments in an active concentration. For simplicity, for clear differentiation between cosmetic and medicinal use and corresponding products, reference is made to the legal provisions of the Federal Republic of Germany (for example cosmetics legislation, food and medical preparations law).

It is known that multiple emulsions—inter alia—can be distinguished by a particularly fine emulsion texture. This property renders them outstandingly suitable as a basis both for cosmetic and for medicinal topical formulations. However, where cosmetics are used only externally, all the customary modes of administration, for example oral administration forms, are conceivable in the case of medicinal use of emulsions.

In simple emulsions, one phase comprises finely disperse droplets of the second phase enclosed by an emulsifier shell (water droplets in W/O or lipid vesicles in O/W emulsions). In a multiple emulsion (of the second degree), on the other hand, more finely disperse droplets of the first phase are emulsified in such droplets. In turn, even more finely disperse droplets can also be present in these droplets (multiple emulsion of the third degree) and so on.

Thus, as W/O or O/W emulsions (water-in-oil or oil-in-water) are referred to in the case of simple emulsions, in the case of multiple emulsions there are W/O/W, O/W/O, O/W/O/W, W/O/W/O emulsions and so on.

Multiple emulsions in which the particular internal and external aqueous phases or internal and external oily phases are of a different type (that is to say, for example, W/O/W′ and O/W/O′ emulsions) can be prepared by two-pot processes. Those emulsions in which the internal and external aqueous and oily phases are not of a different type are obtainable both by one-pot and by two-pot processes.

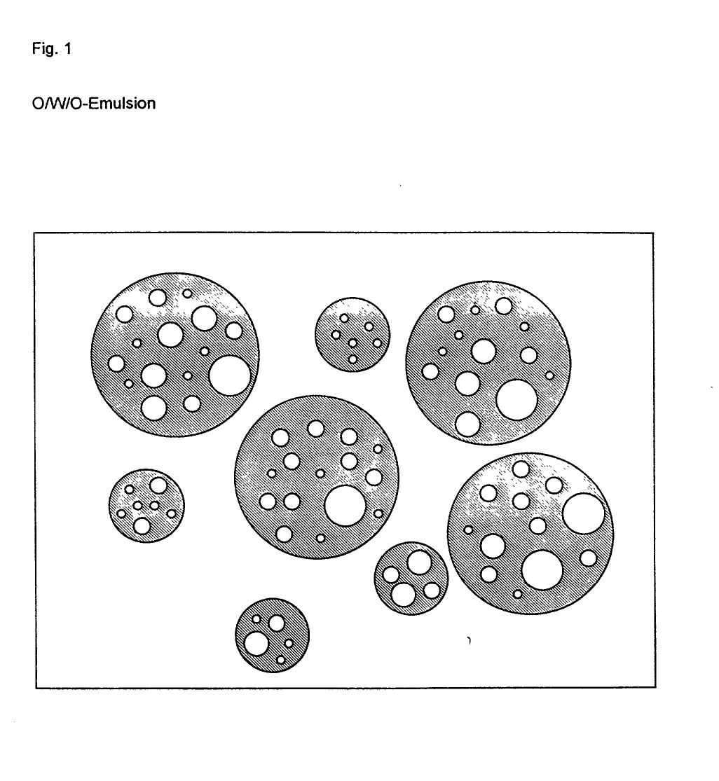

FIG. 1 shows a diagram of an O/W/O emulsion, in which the white areas are the external and internal oily phase and the shaded areas are the aqueous phase. It has not been specified whether the compositions of the external and internal oily phase differ from one another, that is to say whether an O/W/O or an O/W/O′ emulsion is present.

Multiple emulsions of the second degree are occasionally called “bimultiple systems”, those of the third degree are occasionally called “trimultiple systems” and so on (W. Seifriz, Studies in Emulsions, J. Phys. Chem., 29 (1925) 738-749).

The expert is familiar per se with processes for the preparation of multiple emulsions. Thus, there are two-pot processes in which a simple emulsion (for example a W/O emulsion) is initially introduced into the preparation vessel and is converted into a multiple emulsion (for example a W/O/W emulsion) by addition of another phase (for example an aqueous phase) with a corresponding emulsifier (for example an O/W emulsifier).

A second known process comprises converting emulsifier mixtures with an oily phase and an aqueous phase into a multiple W/O/W emulsion in a one-pot process. The emulsifiers are dissolved in the oily phase and the solution is combined with the aqueous phases A pre-requisite for such a process is that the HLB values (HLB=hydrophilic-lipophilic balance) of the individual emulsifiers employed differ significantly from one another.

The definition of the HLB value for polyol fatty acid esters is given by the formula I

HLB=20×(1−H/A)

For a group of emulsifiers in which the hydrophilic content comprises only ethylene oxide units, formula II applies

HLB=E/5

where

H=hydrolysis number of ester,

A=acid number of the acid recovered

E=weight content of ethylene oxide (in %) in the total molecule.

Emulsifiers with HLB values of 6-8 are in general W/O emulsifiers, and those with HLB values of 8-18 are in general O/W emulsifiers. Literature: “Kosmetik—Entwicklung, Herstellung und Anwendung kosmetischer Mittel” [Cosmetics—Development, Preparation and Use of Cosmetic Composition]; W. Umbach (editor), Georg Thieme Verlag 1988.

Hydrophilic emulsifiers (with high HLB values) are as a rule O/W emulsifiers. Accordingly, hydrophobic or lipophilic emulsifiers (with low HLB values) are as a rule W/O emulsifiers.

U.S. Pat. Specification No. 4,931,210 describes a process for the preparation of W/O/W emulsions in which polyglycerol polyricinoleates are used as emulsifiers.

Although multiple emulsions are thus known per se and there are entirely simple processes for their preparation, there has nevertheless to date been a lack of such systems which are stable microscopically over relatively long storage times (for example for several years) or in a wide temperature range (for example from −10° C. to +50° C.) or to extreme variations in temperature (stable to swings, for example, from −15 to +50° C.). This means that the multiple emulsions of the prior art are converted into simple W/O or O/W emulsions in the course of time, that is to say have a low storage stability in the sense of multiplicity. This is a particular disadvantage, since these conversion products as a rule have an extremely inhomogeneous droplet size distribution.

At best, such conversion products are unattractive, or inelegant from the cosmetic aspect. However, the inhomogeneous size distribution of the droplets is often also associated with a lack of macroscopic stability, that is to say stability to decomposition into separate phases.

In this respect also, the conventional multiple emulsions were always either inadequately stable, or transfer from the laboratory scale to large-scale production could not be implemented.

The lack of O/W/O emulsions is a particular disadvantage, since W/O/W emulsions are usually described in the published prior art. Cosmetic or dermatological O/W/O emulsions are currently rather laboratory specialities than products obtainable on the market.

The droplet diameters of the usual “simple”, that is to say non-multiple, emulsions are in the range from about 1 μm to about 50 μm. Without further colouring additives, such “macroemulsions” are milky white in colour and opaque. Finer “macroemulsions”, the droplet diameters of which are in the range from about 10⁻¹ μm to about 1 μm, again without colouring additives, are bluish white in colour and opaque. Such “macroemulsions” usually have a high viscosity.

A clear and transparent appearance is reserved for micellar and molecular solutions with particle diameters of less than about 10⁻² μm, but these are no longer to be interpreted as true emulsions.

The droplet diameter of microemulsions, on the other hand, is in the range from about 10⁻² μm to about 10⁻¹ μm. Microemulsions are translucent and usually of low viscosity. The viscosity of many microemulsions of the O/W type is comparable to that of water.

An advantage of microemulsions is that active compounds can be present in the disperse phase in a considerably more finely disperse form than in the disperse phase of “macroemulsions”. Another advantage is that, because of their low viscosity, they can be sprayed. If microemulsions are used as cosmetics, corresponding products are distinguished by a high cosmetic elegance.

A disadvantage of the microemulsions of the prior art is that a high content of one or more emulsifiers must always be employed, since the small droplet size results in a high interface between the phases, which as a rule must be stabilized by emulsifiers.

Because of their good sprayability, microemulsions are in principle also suitable for other cosmetic dermatological uses, for example deodorants, so that, in a particular embodiment, the present invention relates to microemulsions as a base for cosmetic deodorants.

Cosmetic deodorants serve to eliminate body odour which forms when fresh perspiration, which is odourless per se, is decomposed by microorganisms. The customary cosmetic deodorants are based on different action principles.

In so-called antiperspirants, the formation of perspiration can be reduced by astringents—chiefly aluminium salts, such as aluminium hydroxychloride (aluminium chlorohydrate).

The bacterial flora on the skin may be reduced by the use of antimicrobial substances in cosmetic deodorants. In the ideal case, only the microorganisms which cause odour should be effectively reduced here. The flow of perspiration itself is not influenced as a result, and in the ideal case only the microbial decomposition of the perspiration is temporarily stopped.

The combination of astringents with substances having an antimicrobial action in one and the same composition is also customary.

Deodorants should meet the following conditions:

1) They should have the effect of reliable deodorizing.

2) The natural biological processes of the skin should not be impaired by the deodorants.

3) In the event of an overdose or if otherwise used not as intended, the deodorants must be harmless.

4) They should not accumulate on the skin after repeated use.

5) They should be easy to incorporate into customary cosmetic formulations.

Both liquid deodorants, for example aerosol sprays, roll-ons and the like, and solid formulations, for example deodorant sticks, powders, powder sprays, intimate cleansing compositions and the like, are known and customary.

Although the conventional formulations in emulsion form in general have a good action, they are distinguished to only a limited extent by a care action. The use of microemulsions as a base for deodorizing formulations or formulations having an antiperspirant action is also known. Their relative high content of emulsifiers with the disadvantages described has to date been a poor state of affairs which is to be remedied.

Another object of the present invention was thus to develop formulations which are suitable as a base for cosmetic deodorants or antiperspirants and do not have the disadvantages of the prior art.

It was furthermore an object of the invention to develop cosmetic bases for cosmetic deodorants which are distinguished by a good skin tolerance.

It was moreover an object of the present invention to provide products based on microemulsions or O/W/O emulsions having the broadest possible diversity of use. For example, bases for formulation forms such as cleansing emulsions, face and body care formulations, and also decidedly medicinal-pharmaceutical presentation forms should be provided, for example formulations against acne and other pathological skin symptoms. Finally, the route to emulsions which can be used internally, for example for parenteral feeding, should also be opened up in principle by the present invention.

A particular object of the present invention was to provide finely disperse formulations of the oil-in-water type or multiple emulsions of the O/W/O type having the lowest possible emulsifier content which do not have the disadvantages of the prior art and can be used for the most diverse cosmetic and/or dermatological uses, for example the uses described above. Another object of the invention was to enrich the limited range of finely disperse formulations of the oil-in-water type of the prior art.

It is known that hydrophilic emulsifiers change their solubility properties from water-soluble to fat-soluble with increasing temperature. The temperature range in which the emulsifiers have changed their solubility is called the phase inversion temperature range (PIT).

S. Matsumoto (Journal of Colloid and Interface Science, Volume 94, No. 2, 1983) reports that the development of a W/O/W emulsion precedes a phase inversion of concentrated W/O emulsions stabilized by Span 80, a pronounced W/O emulsifier. Matsumoto starts here from an extremely non-polar oil, that is to say liquid paraffin. Moreover, a certain amount of hydrophilic emulsifiers is said to be necessary for development of a W/O/W emulsion from a W/O emulsion.

T. J. Lin, H. Kurihara and H. Ohta (Journal of the Society of Cosmetic Chemists 26, pages 121-139, March 1975) show that in the case of non-polar oils, extremely unstable multiple emulsions can be present in the region of the PIT.

Microemulsions can also be prepared via phase inversion technology. However, microemulsions of the prior art prepared in such a manner have the disadvantage that firstly the droplet size is still quite high, and secondly a high content of one or more emulsifiers is still necessary.

It is furthermore a disadvantage that although microemulsions prepared in such a manner are practically transparent at a high temperature, that is to say, for example, in the PIT, they become translucent or opaque again on falling to room temperature.

These poor states of affairs were thus also to be remedied.

The object of the present invention was thus to provide stable microemulsions of the O/W type or stable multiple emulsions of the O/W/O or O/W/O′ type and to eliminate the disadvantages of the formulations of the prior art and of their preparation processes.

It has been found, surprisingly, and this accounts for the achievement of the objects, that O/W emulsions, in particular O/W microemulsions, or O/W/O emulsions or O/W/O′ emulsions comprising

an aqueous phase,

if appropriate, customary water-soluble or -dispersible substances,

an oily phase,

at least one emulsifier (emulsifier A) chosen from the group of emulsifiers having the following properties

their lipophilicity either depends on the pH such that the lipophilicity is increased or decreased by raising or lowering the pH, it being unimportant which of the two possible changes in lipophilicity is effected by raising or lowering the pH, and/or

their lipophilicity depends on the temperature such that the lipophilicity increases with increasing temperature and their hydrophilicity increases with decreasing temperature,

and furthermore, if appropriate, further substances which are soluble or dispersible in the oily phase, including, preferably, those chosen from the group of emulsifiers which do not fall under the definition of emulsifier A, in particular those which chiefly act as W/O emulsifiers,

remedy the disadvantages of the prior art.

An advantageous embodiment of the present invention is also a process for the preparation of o/W emulsions, in particular O/W microemulsions, or O/W/O emulsions or O/W/O′ emulsions, characterized in that an aqueous phase, if appropriate, customary water-soluble or

dispersible substances, an oily phase and

at least one emulsifier (emulsifier A) chosen from the group of O/W emulsifiers having the following properties

their lipophilicity depends on the pH such that the lipophilicity is increased or decreased by raising or lowering the pH, it being unimportant which of the two possible changes in lipophilicity is effected by raising or lowering the pH, and

if appropriate, their lipophilicity additionally depends on the temperature such that the lipophilicity increases with increasing temperature and their hydrophilicity increases with decreasing temperature,

and furthermore, if appropriate, further substances which are soluble or dispersible in the oily phase, including, preferably, those chosen from the group of emulsifiers which do not fall under the definition of emulsifier A, are brought together and a mixture is formed, with agitation, such that

by suitable choice of the parameters chosen from the group consisting of pH, temperature and the concentration or concentrations of at least one of the emulsifiers chosen, this mixture is brought into the phase inversion range in which W/O emulsions are converted into O/W emulsions,

by varying at least one parameter chosen from the group consisting of pH, temperature and the concentration or concentrations of at least one of the emulsifiers chosen, the W/O emulsion formed is brought out of the phase inversion range in which a W/O emulsion formed is converted into an O/W emulsion, whereupon an O/W emulsion or O/W microemulsion is produced,

if appropriate, by suitable choice of the framework conditions, another phase inversion to give an O/W/O emulsion is initiated,

if appropriate, the mixture is subjected to further processing steps, in particular one or more homogenizing steps.

Processes which are equally advantageous according to the invention are those in which the variation in the parameter or parameters comprises a procedure in which

(a) at a given pH and given concentration of emulsifier A or of the plurality of emulsifiers A, the temperature of the mixture and, if appropriate, additionally the concentration of at least one further emulsifier A is varied, in which

(b) at a given temperature and given concentration of emulsifier A or of the plurality of emulsifiers A, the pH of the mixture and, if appropriate, additionally the concentration of at least one further emulsifier A is varied, in which

(c) at a given temperature and given pH, the concentration of at least one emulsifier A and, if appropriate, additionally the concentration of at least one further emulsifier A is varied, in which

(d) at a given pH, the temperature of the mixture and additionally the concentration of at least one emulsifier A and, if appropriate, additionally the concentration of at least one further emulsifier A are varied, in which

(e) at a given temperature of the mixture, the pH of the mixture and additionally the concentration of at least one emulsifier A and, if appropriate, additionally the concentration of at least one further emulsifier A are varied, and in which

(f) at a given concentration of at least one emulsifier A, the pH and additionally the temperature of the mixture and, if appropriate, additionally the concentration of at least one further emulsifier A are varied.

If the phase inversion is essentially initiated by varying the temperature, O/W emulsions, in particular O/W microemulsions, are obtainable, the size of the oil droplets essentially being determined by the concentration of the emulsifier or emulsifiers employed such that a higher emulsifier concentration has the effect of smaller droplets and a lower emulsifier concentration leads to larger droplets. If the phase inversion is essentially initiated by varying the temperature, it is entirely advantageous to dispense with further emulsifiers which do not fall under the definition of emulsifier A, that is to say W/O emulsifiers.

If the phase inversion is essentially initiated by varying the pH, O/W emulsions, in particular O/W microemulsions, and also O/W/O emulsions are obtainable. If the phase inversion is essentially initiated by varying the pH, it is entirely advantageous to employ one or more further emulsifiers which do not fall under the definition of emulsifier A, that is to say W/O emulsifiers.

O/W/O emulsions can be obtained according to the invention if the oily phase content is greater than about 15% by weight, in particular greater than about 20% by weight, based on the total weight of the formulation, more than about 5% by weight, in particular about 5-10% by weight, of an additional W/O emulsifier which does not fall under the definition of emulsifier A is present, and/or if the oily phase has a low content of polar oils.

O/W microemulsions can be obtained according to the invention if the oily phase content is less than about 20% by weight, in particular less than about 15% by weight, based on the total weight of the formulation, less than about 5% by weight of an additional W/O emulsifier which does not fall under the definition of emulsifier A is present, and/or if the oily phase has a high content of polar oils.

O/W emulsions (“macroemulsions”) can be obtained according to the invention if less than about 5% by weight of an additional W/O emulsifier which does not fall under the definition of emulsifier A and more than about 20% by weight of a polar oily phase are present. Additional gel-forming agents (for example carbopols, xanthan gum, cellulose derivatives) can advantageously be employed.

In the individual case, it is possible that the concentration easily exceeds or falls below the above-mentioned limits, and nevertheless the emulsion types in question are obtained. In view of the wide-ranging diversity of suitable emulsifiers and oil constituents, this is not unexpected to the expert, so that he knows that such excesses or deficits do not leave the basis of the present invention.

The phase inversion range can be demonstrated mathematically as a point quantity within the straight-line coordinate system Σ formed by the parameters of temperature, pH and concentration of a suitable emulsifier or of an emulsifier mixture in the formulation, in accordance with:

Σ={O, θ, a, m}

where

O—coordinate origin

θ—temperature

a—pH

m—concentration

In precise terms, in a multi-component emulsifier system, the amount mᵢ of each individual emulsifier must of course be taken into account to give the total function, which, in the case of an i-component emulsifier system, leads to the relationship

Σ={O, θ, a, m₁, m₂, . . . , mᵢ}.

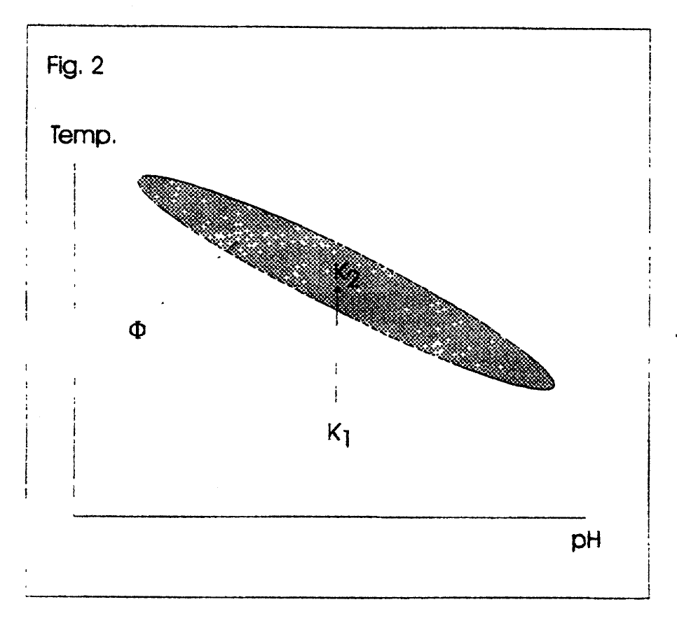

The phase inversion range Φ in the mathematical sense here is a continuous region or a plurality of continuous regions within the coordinate system Σ. Φ represents the total amount of coordinate points K (θ, a, m₁, m₂, . . . , mᵢ) which determine mixtures according to the invention of an aqueous and oily phase and i emulsifiers according to the invention of concentration mᵢ at the temperature θ and the pH a, and for which phase inversion occurs on transition from one coordinate K₁ ∉ Φ to a coordinate K₂ ε Φ, as described in FIG. 2. The temperature and pH of a given mixture keeping the concentration of m₁=mᵢ constant have been shown as variable coordinates in FIG. 2. On transition from K₁ to K₂, only the temperature is increased.

Under the conditions according to the invention, this process is not reversible, i.e. if the system reverts from coordinate K₂ ε Φ back to coordinate K₁ ∉ Φ, other types of emulsion than would have been expected from the prior art can be obtained according to the invention. For example, if, by increasing the temperature of a mixture according to the invention of aqueous and oily phase and i emulsifiers according to the invention of concentrations mᵢ, the pH a remaining constant, starting from a temperature which is too low for phase inversion (that is to say conditions where a conventional O/W emulsion would be present and would also remain as such on cooling to room temperature), the system is heated such that phase inversion occurs, after cooling, for example to room temperature, no conventional O/W emulsion but an O/W microemulsion according to the invention is obtained. Alternatively, mutatis mutandis: an O/W/O emulsion according to the invention.

It is unimportant here whether the phase inversion range of a given system is a single continuous (i+2)-dimensional region or comprises several such regions which are continuous but separate from one another, i.e. corresponding to several phase inversion ranges of a given system. In the context of the disclosure submitted here, one phase inversion range is therefore always referred to as a generalization, even if two or more such ranges which are separate from one another exist.

The practice of preparation of an emulsion according to the invention advantageously comprises a procedure in which, after selection of suitable raw materials, i.e. the aqueous and oily phase, one or more emulsifiers of type A, the latter present in concentrations at which phase inversion for the given mixture is possible, and, if appropriate, further substances, the individual components are heated, with agitation, to a temperature at which phase inversion is possible for the given mixture, and phase inversion is brought about by raising or lowering the pH of the mixture, after which the mixture is allowed to cool to room temperature, while continuing agitation. One or more intermediate homogenization steps are advantageous but not absolutely necessary.

Another advantageous embodiment of the process according to the invention comprises a procedure in which, after selection of suitable raw materials, i.e. the aqueous and oily phase, one or more emulsifiers of type A, the latter present in concentrations at which phase inversion for the given mixture is possible, and, if appropriate, further substances, the individual components are brought, with agitation, to a pH at which phase inversion is possible for the given mixture, and phase inversion is brought about by increasing the temperature of the mixture, after which the mixture is allowed to cool to room temperature, while continuing agitation. One or more intermediate homogenization steps are advantageous but not absolutely necessary.

A third advantageous embodiment of the process according to the invention comprises a procedure in which, after selection of suitable raw materials, i.e. the aqueous and oily phase, one or more emulsifiers of type A and, if appropriate, further substances, the individual components are brought, with agitation, to a pH and a temperature at which phase inversion is possible for the given mixture, and phase inversion is brought about by addition of emulsifier A or emulsifiers A to the mixture, after which the mixture is allowed to cool to room temperature, while continuing agitation. One or more intermediate homogenization steps are advantageous but not absolutely necessary.

In practice, it is possible and, where appropriate, even advantageous for the temperature range which can be assigned to the phase inversion range also to be exceeded during preparation of an emulsion according to the invention, since the mixture necessarily passes through this range on cooling to room temperature.

The emulsifiers A are preferably chosen from the group consisting of emulsifiers which are good proton donors or proton acceptors, where it must be ensured that their lipophilicity depends on the pH such that the lipophilicity is increased or decreased by raising or lowering the pH, it being unimportant in principle which of the two possible changes in lipophilicity is effected by raising or lowering the pH, and, if appropriate, their lipophilicity additionally depends on the temperature such that their lipophilicity increases with increasing temperature and their hydrophilicity increases with decreasing temperature.

The lipid phase can advantageously be chosen from the following group of substances:

oils, such as triglycerides of capric or of caprylic acid

fats, waxes and other naturally occurring and synthetic fat substances, preferably esters of fatty acids with alcohols of low C number, for example with isopropanol, propylene glycol or glycerol, or esters of fatty alcohols with alkanoic acids of low C number or with fatty acids; and

alkyl benzoates.

The lipid phase can especially advantageously be chosen from the group consisting of silicone oils, such as dimethylpolysiloxanes, diethylpolysiloxanes, diphenylpolysiloxanes and mixed forms of these.

If appropriate, the aqueous phase of the formulations according to the invention advantageously comprises

alcohols, diols or polyols of low C number and ethers thereof, preferably ethanol, isopropanol, propylene glycol, glycerol, ethylene glycol, ethylene glycol monoethyl or monobutyl ether, propylene glycol monomethyl, monoethyl or monobutyl ether, diethylene glycol monomethyl or monoethyl ether and analogous products, furthermore alcohols of low C number, for example ethanol, isopropanol, 1,2-propanediol and glycerol, and, in particular, one or more thickeners, which can advantageously be chosen from the group consisting of silicon dioxide, aluminium silicates, polysaccharides and derivatives thereof, for example hyaluronic acid, xanthan gum and hydroxypropylmethylcellulose, particularly advantageously from the group consisting of polyacrylates, preferably a polyacrylate from the group consisting of so-called carbopols, for example carbopols of types 980, 981, 1382, 2984 and 5984, in each case individually or in combination.

The emulsifiers of type A are advantageously chosen from the group consisting of sorbitan esters and sucrose esters, in particular of branched and unbranched alkyl esters and alkenyl esters having carbon chains of 4-24 carbon atoms, preferably sorbitan stearate, sorbitan oleate, glycerylsorbitan stearate, sucrose monostearate, sucrose monolaurate and sucrose palmitate.

The emulsifiers of type A can advantageously be chosen from the group consisting of monoglycerol monocarboxylic acid monoesters, in particular those which are characterized by the structures

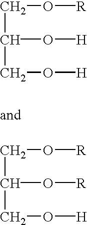

wherein R is a branched or unbranched acyl radical having 6-14 carbon atoms. R is advantageously chosen from the group consisting of unbranched acyl radicals. The fatty acids or monocarboxylic acids on which these esters are based are

| | |
|---|---|
| hexanoic acid (caproic acid) | (R = —C(O)—C₅H₁₁), |
| heptanoic acid Coenanthic acid) | (R = —C(O)—C₆H₁₃), |
| octanoic acid (caprylic acid) | (R = —C(O)—C₇H₁₅), |
| nonanoic acid (pelargonic acid) | (R = —C(O)—C₈H₁₇), |
| decanoic acid (capric acid) | (R = —C(O)—C₉H₁₉), |
| undecanoic acid | (R = —C(O)—C₁₀H₂₁), |
| dodecanoic acid Clauric acid) | (R = —C(O)—C₁₁H₂₃), |
| tridecanoic acid | (R = —C(O)—C₁₂H₂₅), |
| tetradecanoic acid (myristic acid) | (R = —C(O)—C₁₃H₂₇). |

R is particularly advantageously the octanoyl radical (caprylic acid radical) or the decanoyl radical (capric acid radical), that is to say is represented by the formulae

R=—C(O)—C₇H₁₅ or R=—C(O)—C₉H₁₉.

Advantageously, the emulsifiers of type A can also be chosen from the group consisting of di- and triglycerol monocarboxylic acid monoesters. According to the invention, the di- or triglycerol units of the diglycerol monocarboxylic acid monoesters or triglycerol monocarboxylic acid monoesters according to the invention are present as linear, unbranched molecules, that is to say “monoglycerol molecules” etherified via the particular OH groups in the 1- and 3-position.

A small content of cyclic di- or triglycerol units and glycerol molecules etherified via the OH groups in the 2-position can be tolerated. However, it is advantageous to keep such impurities as low as possible.

The monocarboxylic acid monoesters according to the invention are preferably characterized by the following structure (substitution positions shown):

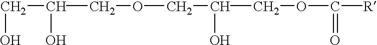

wherein R′ is a hydrocarbon radical, advantageously a branched or unbranched alkyl or alkenyl radical having 5 to 17 C atoms.

The triglycerol monocarboxylic acid esters according to the invention are preferably characterized by the following structure (substitution positions shown):

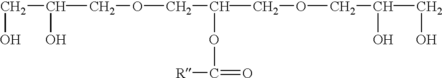

wherein R″ is a hydrocarbon radical, advantageously a branched or unbranched alkyl or alkenyl radical having 5 to 17 C atoms.

The acids on which these esters are based are

| | |
|---|---|
| hexanoic acid (caproic acid) | (R′ or R″ = —C₅H₁₁), |
| heptanoic acid (oenanthic acid) | (R′ or R″ = —C₆H₁₃), |
| octanoic acid (caprylic acid) | (R′ or R″ = —C₇H₁₅), |
| nonanoic acid (pelargonic acid) | (R′ or R″ = —C₈H₁₇), |
| decanoic acid (capric acid) | (R′ or R″ = —C₉H₁₉), |
| undecanoic acid | (R′ or R″ = —C₁₀H₂₁), |
| 10-undecenoic acid (undecylenic acid) | (R′ or R″ = —C₁₀H₁₉), |
| dodecanoic acid (lauric acid) | (R′ or R″ = —C₁₁H₂₃) |
| tridecanoic acid | (R′ or R″ = —C₁₂H₂₅), |
| tetradecanoic acid (myristic acid) | (R′ or R″ = —C₁₃H₂₇), |
| pentadecanoic acid | (R′ or R″ = —C₁₄H₂₉), |
| hexadecanoic acid (palmitic acid) | (R′ or R″ = —C₁₅H₃₁), |
| heptadecanoic acid (margaric acid) | (R′ or R″ = —C₁₆H₃₃), |
| octadecanoic acid (stearic acid) | (R′ or R″ = —C₁₇H₃₅). |

R′ and R″ are particularly favourably chosen from the group consisting of unbranched alkyl radicals having odd C numbers, in particular having 9, 11 and 13 C atoms.

The monocarboxylic acid monoesters of diglycerol are generally preferable to those of triglycerol.

Especially favourable according to the invention are

| | | |
|---|---|---|
| diglycerol monocaprate (DMC) | R′ = | 9 |
| triglycerol monolaurate (TML) | R″ = | 11 |
| diglycerol monolaurate (DML) | R′ = | 11 |
| triglycerol monomyristate (TMM) | R′ = | 13. |

Diglycerol monocaprate (DMC) has proved to be the preferred diglycerol monocarboxylic acid monoester according to the invention.

According to an advantageous embodiment of the present invention, an additional content of di- or triglycerol esterified at other points, and also optionally a content of the various diesters of di- or triglycerol, are used.

Triglyceryl diisostearate (nomenclature analogous to CTFA: polyglyceryl 3-diisostearate), isostearyl-diglyceryl succinate, diglyceryl sesquiisostearate (nomenclature analogous to CTFA: polyglyceryl 2-sesquiisostearate), triglyceryl polyhydroxystearate (nomenclature analogous to CTFA: polyglyceryl 2-polyhydroxystearate) are also advantageous.

Cetearyl isononanoate, dicocoylpentaenythrityl distearyl citrate, also the methicone copolyols, cyclomethicone copolyols, alkylimethicane copolyols, especially laurylmethicone copolyol, cetyldimethicone copolyol, have also proved advantageous according to the invention.

The emulsifier or emulsifiers of type A are especially advantageously chosen from the group consisting of branched or unbranched alkylmonocarboxylic acids, alkenylmonocarboxylic acids and alkylenedicarboxylic acids having 4 to 30 carbon atoms, in particular stearic acid, oleic acid, succinic acid, hexanoic acid (caproic acid), heptanoic acid (oenanthic acid), octanoic acid (caprylic acid), nonanoic acid (pelargonic acid), decanoic acid (capric acid), undecanoic acid, undecenoic acid (undecylenic acid), dodecanoic acid (lauric acid), tridecanoic acid, tetradecanoic acid (myristic acid), pentadecanoic acid, hexadecanoic acid (palmitic acid), heptadecanoic acid (margaric acid), octadecanoic acid (stearic acid), isostearic acid and behenic acid. It is also advantageous to choose the emulsifiers A from the group consisting of cosmetically or pharmaceutically acceptable salts of the abovementioned carboxylic acids, in particular of the alkali metal, ammonium, monoalkylammonium, dialkylammonium, trialkylammonium and tetraalkylammonium salts.

The emulsifier or emulsifiers A are likewise particularly advantageously chosen from the group consisting of mono-, oligo- and polyethoxylated compounds, in particular polyethoxylated mono- or polyfunctional alcohols or fatty acids, for example ceteareth-20, PEG 20-glyceryl stearate, steareth-20, PEG 20-stearate, PEG 30-stearate, PEG 40-castor oil, PEG 1-glycerol sorbitan oleostearate, PEG 7-hydrogenated castor oil, PEG 40-sorbitan peroleate and PEG 45-dodecylglycol copolymer.

The emulsions according to the invention are advantageously characterized in that the emulsifier A or the emulsifiers A is or are present in concentrations of 0.01-20% by weight, preferably 0.05-10% by weight, particularly preferably 0.1-5% by weight, in each case based on the total weight of the composition.

If the O/W/O emulsions or O/W microemulsions according to the invention are bases for cosmetic deodorants/antiperspirants, all the customary active compounds can advantageously be used, for example odour maskers, such as the customary perfume constituents, odour absorbers, for example the laminar silicates described in Patent Publication DE-P 40 09 347, and of these in particular montmorillonite, kaolinite, ilite, beidellite, nontronite, saponite, hectorite, bentonite and smectite, and furthermore, for example, zinc salts of ricinoleic acid. Germ-inhibiting agents are likewise suitable for incorporation into the microemulsions according to the invention. Advantageous substances are, for example, 2,4,4′-trichloro-2′-hydroxydiphenyl ether (irgasan), 1,6-di(4-chlorophenylbiguanido)hexane (chlorhexidine), 3,4,4′-trichlorocarbanilide, quaternary ammonium compounds, oil of cloves, mint oil, oil of thyme, triethyl citrate, rarnesol (3,7,11-trimethyl-2,6,10-dodecatrien-1-ol) and the active agents described in DE-OS 37 40 186, DE-OS 39 38 140, DE-OS 42 04 321, DE-OS 42 29 707, DE-OS 42 29 737, DE-OS 42 37 081, DE-OS 43 09 372 and DE-OS 43 24 219.

The customary antiperspirant active compounds can likewise advantageously be used in the formulations according to the invention, in particular astringents, for example basic aluminium chlorides.

The cosmetic deodorants according to the invention can be in the form of aerosols, that is to say preparations which can be sprayed from aerosol containers, squeeze bottles or by a pump device, or in the form of liquid compositions which can be applied by means of roll-on devices, but also in the form of formulations which can be applied from normal bottles and containers.

Suitable propellants for cosmetic formulations, for example deodorants, according to the invention which can be sprayed from aerosol containers are the customary known readily volatile liquefied propellants, for example hydrocarbons (propane, butane, isobutane), which can be employed by themselves or as a mixture with one another. Compressed air can also advantageously be used.

The expert of course knows that there are propellant gases which are non-toxic per se and would be suitable in principle for the present invention, but which should nevertheless be omitted because of an unacceptable effect on the environment or other concomitant circumstances, in particular chlorofluorohydrocarbons (CFCs).

In order to obtain low-viscosity microemulsions according to the invention, in particular those which can be sprayed, it is particularly advantageous if the oily phase comprises constituents which have a melting point below 40° C. in the smallest possible amount, and in the ideal case no such constituents.

The cosmetic formulations according to the invention can comprise cosmetic auxiliaries such as are usually used in such formulations, for example preservatives, bactericides, substances having a deodorizing action, antiperspirants, insect repellants, vitamins, agents for preventing foaming, dyestuffs, pigments having a colouring action, thickeners, softening substances, humidifying and/or humectant substances, fats, oils, waxes or other customary constituents of a cosmetic formulation, such as alcohols, polyols, polymers, foam stabilizers, electrolytes, organic solvents or silicone derivatives.

According to the invention, the formulations according to the invention advantageously comprise one or more antioxidants. All the naturally occurring, synthetic and/or semi-synthetic antioxidants which are suitable or customary for cosmetic and/or dermatological uses can be used as favourable antioxidants which are nevertheless optionally to be used.

The antioxidants are particularly advantageously chosen from the group consisting of amino acids (for example glycine, histidine, tyrosine, tryptophan) and derivatives thereof, imidazoles (for example urocanic acid) and derivatives thereof, peptides, such as D,L-carnosine, D-carnosine, L-carnosine and derivatives thereof (for example anserine), carotenoids, carotenes (for example α-carotene, β-carotene, lycopene) and derivatives thereof, lipoic acid and derivatives thereof (for example dihydrolipoic acid), aurothioglucose, propylthiouracil and other thiols (for example thioredoxin, glutathione, cysteine, cystine, cystamine and the glycosyl, N-acetyl, methyl, ethyl, propyl, amyl, butyl and lauryl, palmitoyl, oleyl, γ-linoleyl, cholesteryl and glyceryl esters thereof) and salts thereof, dilauryl thiodipropionate, distearyl thiodipropionate, thiodipropionic acid and derivatives thereof (esters, ethers, peptides, lipids, nucleotides, nucleosides and salts) and sulphoximine compounds (for example buthionine-sulphoximines, homocysteine-sulphoximine, buthionine-sulphones, penta-, hexa- and heptathionine-sulphoximine) in very low tolerated dosages (for example pmol to μmol/kg), and furthermore (metal) chelating agents (for example 60 -hydroxy-fatty acids, palmitic acid, phytic acid, lactoferrin), α-hydroxy acids (for example citric acid, lactic acid, malic acid), humic acid, bile acid, bile extracts, bilirubin, biliverdin, EDTA, EGTA and derivatives thereof, unsaturated fatty acids and derivatives thereof (for example γ-linolenic acid, linoleic acid, oleic acid), folic acid and derivatives thereof, ubiquinone and ubiquinol and derivatives thereof, vitamin C and derivatives (for example ascorbyl palmitate, Mg ascorbyl phosphates, ascorbyl acetates), tocopherols and derivatives (for example vitamin E acetate), vitamin A and derivatives (for example vitamin A palmitate) and coniferyl benzoate of benzoin resin, flavones or flavonoids, rutic acid and derivatives thereof, ferulic acid and derivatives thereof, butylhydroxytoluene, butylhydroxyanisole, nordihydroguaiac resin acid, nordihydroguaiaretic acid, trihydroxybutyrophenone, uric acid and derivatives thereof, mannose and derivatives thereof, zinc and derivatives thereof (for example ZnO, ZnSO₄), selenium and derivatives thereof (for example selenium methionine), stilbenes and derivatives thereof (for example stilbene oxide, trans-stilbene oxide) and the derivatives of these active compounds mentioned which are suitable according to the invention (salts, esters, ethers, sugars, nucleotides, nucleosides, peptides and lipids).

It is furthermore advantageous to add to the formulations according to the invention enzymes, co-enzymes, in particular biotin or biotin esters, and also other substances of this or a related type which are customary in cosmetics and dermatology, for example activators, such as citric acid.

It is advantageous according to the invention to employ in the formulations according to the invention additional oil-soluble UVA filters and/or UVB filters in the lipid phase and/or water-soluble UVA filters and/or UVB filters in the aqueous phase.

The formulations according to the invention can advantageously furthermore comprise substances which absorb UV radiation in the UVB range, the total amount of filter substances being, for example, 0.1% by weight to 30% by weight, preferably 0.5 to 10% by weight, in particular 1 to 6% by weight, based on the total weight of the formulation, in order to provide cosmetic formulations which protect the skin from the entire range of ultraviolet radiation. They can also be used as sunscreen compositions.

Formulations according to the invention, for example in the form of a sunscreen cream, a sunscreen lotion or a sunscreen milk, are advantageous and comprise, for example, the fats, oils, waxes and other fat substances mentioned, as well as water.

The UVB filters can be oil-soluble or water-soluble. Advantageous oil-soluble UVB filter substances are, for example:

3-benzylidenecamphor derivatives, preferably 3-(4-methylbenzylidene)camphor and 3-benzylidenecamphor;

4-aminobenzoic acid derivatives, preferably 2-ethylhexyl 4-(dimethylamino)benzoate and amyl 4-(dimethylamino)benzoate;

esters of cinnamic acid, preferably 2-ethylhexyl 4-methoxycinnamate and isopentyl 4-methoxycinnamate;

derivatives of benzophenone, preferably 2-hydroxy-4-methoxybenzophenone, 2-hydroxy-4-methoxy-4′-methylbenzophenone and 2,2′-dihydroxy-4-methoxybenzophenone;

esters of benzylmalonic acid, preferably di (2-ethylhexyl) 4-methoxybenzalmalonate;

2,4,6-trianilino-(p-carbo-2′-ethyl-1′-hexyloxy)-1,3,5-triazine.

Advantageous water-soluble UVB filter substances are, for example:

salts of 2-phenylbenzimidazole-5-sulphonic acid, such as its sodium, potassium or its triethanolammonium salt, and the sulphonic acid itself;

sulphonic acid derivatives of benzophenones, preferably 2-hydroxy-4-methoxybenzophenone-5-sulphonic acid and salts thereof;

sulphonic acid derivatives of 3-benzylidenecamphor, such as, for example, 4-(2-oxo-3-bornylidenemethyl)benzenesulphonic acid, 2-methyl-5-(2-oxo-3-bornylidenemethyl)benzenesulphonic acid and salts thereof.

The list of UVB filters mentioned which can be used in combination with the active compound combinations according to the invention is of course not intended to be limiting.

It may also be advantageous to combine the combinations according to the invention with UVA filters which have usually been contained to date in cosmetic formulations. These substances are preferably derivatives of dibenzoylmethane, in particular 1-(4′-tert-butyl-phenyl)-3-(4′-methoxyphenyl)propane-1,3-dione and 1-phenyl-3-(4′-isopropylphenyl)propane-1,3-dione. The invention also relates to these combinations and to formulations which comprise these combinations. The amounts used for the UVB combination can be employed.

It is furthermore advantageous to combine the active compound combinations according to the invention with further UVA and/or UVB filters.

The total amount of UVA filter substances can advantageously be 0.1% by weight to 30% by weight, preferably 0.5 to 10% by weight, in particular 1 to 6% by weight, based on the total weight of the formulation, in order to provide cosmetic formulations which protect the skin from the entire range of ultraviolet radiation and in which the stinging of the α-hydroxycarboxylic acids or α-ketocarboxylic acids is prevented or drastically reduced.

Those cosmetic and dermatological formulations which are in the form of a sunscreen composition or a pre-soleil or apres-soleil product are also advantageous. Advantageously, these additionally comprise at least one UVA filter and/or at least one UVB filter.

Those cosmetic and dermatological formulations which are in the form of a sunscreen composition or a pre-soleil or apres-soleil product and comprise one or more antioxidants in addition to the UVA filter or filters and/or the UVB filter or filters are furthermore also advantageous.

Cosmetic and dermatological formulations according to the invention preferably comprise inorganic pigments based on metal oxides and/or other metal compounds which are sparingly soluble or insoluble in water, in particular the oxides of titanium (TiO₂), zinc (ZnO), iron (for example Fe₂O₃), zirconium (ZrO₂), silicon (SiO₂), manganese (for example MnO), aluminium (Al₂O₃) or cerium (for example Ce₂O₃), mixed oxides of the corresponding metals and mixtures of such oxides. The pigments are particularly preferably those based on TiO₂.

A prerequisite for the usability of inorganic pigments for purposes according to the invention is of course cosmetic and dermatological acceptability of the substances on which they are based.

It is advantageous to choose the particle diameter of the pigments used at less than 100 nm.

According to the invention, the inorganic pigments are present in hydrophobic form, i.e. they have been given a water-repellent treatment on the surface. This surface treatment can comprise providing the pigments with a thin hydrophobic layer by processes known per se.

Such a process comprises, for example, a procedure in which the hydrophobic surface layer is produced by a reaction according to n TiO₂+m (RO)₃Si—R′→n TiO₂ (surface). n and m here are stoichiometric parameters to be employed as desired and R and R′ are the desired organic radicals. Hydrophobized pigments prepared analogously to DE-OS 33 14 742, for example, are advantageous.

Advantageous TiO₂ pigments are obtainable, for example, under the tradenames T 805 (DEGUSSA) or M 262 (KEMIRA) or M 160 (KEMIRA) or MT 100 T (TAYCA).

Advantageous SiO₂ pigments can be chosen from the series of hydrophobic pigments marketed under the tradenames AEROSIL (DEGUSSA), for example AEROSIL R 812 or AEROSIL R 972.

Formulations according to the invention are advantageously characterized by a content of 0.1 to 10% by weight, in particular 0.5-5.0% by weight, of hydrophobic inorganic pigments, in each case based on the total weight of the composition.

The emulsions according to the invention can in principle fulfil all the cosmetic intended uses which emulsions usually have to fulfil, for example day creams, night creams, hand or body creams, sunscreen formulations, nutrient creams, liposome creams, vitamin creams and so on.

It is advantageous here to use the formulations according to the invention both in the field of care cosmetics and in the field of decorative cosmetics.

Where appropriate, however, it is also advantageous to use formulations according to the invention as a carrier substance of dermatological or topical formulations.

Some peculiarities and differences in the pre-requisites of O/W emulsions, O/W microemulsions and O/W/O emulsions according to the invention will also be briefly discussed below.

Oils and fats differ, inter alia, in their polarity, which is difficult to define. It has already been proposed to adopt the surface tension with respect to water as a measure of the polarity index of an oil or of an oily phase. In this case, the polarity of the oily phase in question is greater, the lower the surface tension between this oily phase and water. According to the invention, the surface tension is regarded as a possible measure of the polarity of a given oil component.

The surface tension is that force which acts on an imaginary line of one meter in length in the interface between two phases. The physical unit for this surface tension is conventionally calculated from the relationship force/length and is usually expressed in mN/m (millinewtons divided by meters). It has a positive sign if it endeavours to reduce the interface. In the converse case, it has a negative sign.

According to the invention, the limit below which an oily phase is “polar” and above which an oily phase is “non-polar” is regarded as 30 mN/m.

According to the invention, the oily phase for O/W microemulsions is advantageously chosen from the group consisting of polar oil components which have a polarity of between 10 and 30 mN/m, where it must be ensured that at least one non-polar oil component is present.

Advantageous O/W microemulsions are obtained if the oily phase is chosen from the group consisting of polar oil components, particularly preferably the group consisting of naturally occurring, synthetic or semisynthetic oil components which have a polarity of between 10 and 20 mN/m, where it must be ensured that at least one non-polar oil component is present.

It is also advantageous to use polar vegetable oils as polar oils of the O/W emulsions according to the invention. The vegetable oils can advantageously be chosen from the group consisting of oils of the plant families Euphorbiaceae, Poaceae, Fabaceae, Brassicaceae, Pedalaceae, Asteraceae, Linaceae, Flacourticaceae and Violales, preferably chosen from the group consisting of natural castor oil, wheat germ oil, grapeseed oil, candlenut oil, safflower oil, thistle oil, oil of evening primrose and other oils which comprise at least 1.5% by weight of linoleic acid glycerides.

In contrast, O/W/O emulsions according to the invention should have only minor amounts of such oil components, and instead of these should have chiefly those of which the polarity value is higher than 30 mN/m. Naturally occurring, synthetic and semi-synthetic oils, fats and waxes have similarly proved to be advantageous.

The addition of electrolytes causes a change in the solubility properties of a hydrophilic emulsifier. The hydrophilic emulsifiers having the structures or properties described above pass through a partial phase inversion in which solubilization of water by the oily phase occurs, resulting in a stable microemulsion or, in the desired case, also a stable O/W/O emulsion.

The microemulsions according to the invention therefore advantageously comprise electrolytes, in particular one or more salts with the following anions: chlorides, and furthermore inorganic oxo element anions, and of these in particular sulphates, carbonates, phosphates, borates and aluminates. Electrolytes based on organic anions can also advantageously be used, for example lactates, acetates, benzoates, propionates, tartrates, citrates and many others. Comparable effects can also be achieved by ethylenediaminetetraacetic acid and salts thereof.

Cations of the salts which are preferably used are ammonium, alkylammonium, alkali metal, alkaline earth metal, magnesium, iron and zinc ions. It does not need mentioning that only physiologically acceptable electrolytes should be used in cosmetics. On the other hand, specific medicinal uses of the microemulsions according to the invention may at least in principle require the use of electrolytes which should not be used without medical supervision.

Potassium chloride, sodium chloride, magnesium sulphate, zinc sulphate and mixtures thereof are particularly preferred. Salt mixtures such as occur in the natural salt of the Dead Sea are likewise advantageous.

The concentration of the electrolyte or electrolytes should be about 0.01-10.0% by weight, particularly advantageously about 0.03-8.0% by weight, based on the total weight of the formulation.

The emulsifiers of type A can customarily be regarded as O/W emulsifiers. A content of about 5-10% by weight of the usual W/O emulsifiers advantageously promotes the formation of O/W/O emulsions, and a content of significantly more than 10% by weight of such emulsifiers leads to destabilization of the O/W/O emulsions.

If desired, for the preparation of O/W/O emulsions according to the invention, it is furthermore advantageous to employ hydrophilic and/or lipophilic gel-forming agents. Although these as a rule do not contribute towards the formation of multiple droplets, they promote the stability of multiple drops once formed.

If the pH is to be varied in a preparation process according to the invention for O/W/O emulsions, in order to bring an otherwise predetermined system into the phase inversion range, it is advantageous initially to employ the lowest possible electrolyte concentration in the aqueous phase at the start of the process, and if possible initially to omit this concentration entirely. It is furthermore advantageous for emulsifier A to be initially introduced into the oily phase, for example for stearic acid in the concentration range of 0.5-5% by weight, in particular 2% by weight. The presence of an emulsifier which does not fall under the definition of emulsifier A in the concentration range of about 5-10% by weight, in particular about 7% by weight, is advantageous.

The pH should advantageously first be varied when the W/O emulsion has formed, for example by addition of NaOH.

It lies here within the general expertise of the expert and requires no inventive step at all to determine the temperature or pH range in which phase inversion takes place for a given emulsifier or a given emulsifier system in a given aqueous/oily phase system. As a general guideline for the PIT at the usual emulsifier concentrations, a temperature range of about 40-90° C. can be stated. In general, the PIT drops as the emulsifier concentration increases.

During this process, if desired, the base substances, auxiliaries, additives and/or active compounds customary in cosmetics or medicine formulations can furthermore be added. It is clear to the expert at what point in time such substances can be added to the process without the properties of the emulsion to be achieved being substantially impaired.

The following examples are intended to outline the essence of the present invention in more detail without limiting the invention.

### EXAMPLE 1

O/W microemulsion

| | % by weight |
|---|---|
| Ceteareth-12 | 8.00 |
| Cetearyl isononanoate | 20.00 |
| Cetearyl alcohol | 4.00 |
| Uvinul ® T 150 | 2.00 |
| Parsol ® 1789 | 1.00 |
| Eusolex ® 232 | 4.80 |
| | pH = 7.5 |
| Dyestuffs, perfume, preservative | q.s. |
| Water | to 100.00 |

The UV filters are dissolved in the oily phase and combined with the other constituents of the oily phase, after which the mixture is homogenized, subsequently combined with the aqueous phase and brought to a temperature of 80-85° C. (i.e. into the phase inversion temperature range of the system), and the system is then cooled to room temperature (that is to say is brought out of the phase inversion temperature range of the system again).

### EXAMPLE 2

O/W microemulsion

| | % by weight |
|---|---|
| Ceteareth-12 | 12.00 |
| Cetearyl isononanoate | 20.00 |
| Cetearyl alcohol | 6.00 |
| Uvinul ® T 150 | 2.00 |
| Eusolex ® 6300 | 3.00 |
| Eusolex ® 232 | 4.80 |
| | pH = 7.5 |
| Dyestuffs, perfume, preservative | q.s. |
| Water | to 100.00 |

The UV filters are dissolved in the oily phase and combined with the other constituents of the oily phase, after which the mixture is homogenized, subsequently combined with the aqueous phase and brought to a temperature of 80-85° C. (i.e. into the phase inversion temperature range of the system), and the system is then cooled to room temperature (that is to say is brought out of the phase inversion temperature range of the system again).

### EXAMPLE 3

O/W microemulsion

| | % by weight |
|---|---|
| Ceteareth-12 | 8.00 |
| Cetearyl isononanoate | 20.00 |
| Cetearyl alcohol | 4.00 |
| Uvinul ® T 150 | 4.80 |
| MgSO₄ | 3.00 |
| Dyestuffs, perfume, preservative | q.s. |
| Water | to 100.00 |

The UV filters are dissolved in the oily phase and combined with the other constituents of the oily phase, after which the mixture is homogenized, subsequently combined with the aqueous phase and brought to a temperature of 80-85° C. (i.e. into the phase inversion temperature range of the system), and the system is then cooled to room temperature (that is to say is brought out of the phase inversion temperature range of the system again).

### EXAMPLE 4

O/W microemulsion

| | % by weight |
|---|---|
| Ceteareth-12 | 12.00 |
| Cetearyl isononanoate | 20.00 |
| Cetearyl alcohol | 6.00 |
| Uvinul ® T 150 | 4.80 |
| Parsol ® 1789 | 2.00 |
| TiO₂ | 2.00 |
| MgSO₄ | 3.00 |
| Dyestuffs, perfume, preservative | q.s. |
| Water | to 100.00 |

The UV filters are dissolved in the oily phase and combined with the other constituents of the oily phase, after which the mixture is homogenized, subsequently combined with the aqueous phase and brought to a temperature of 80-85° C. (i.e. into the phase inversion temperature range of the system), and the system is then cooled to room temperature (that is to say is brought out of the phase inversion temperature range of the system again).

### EXAMPLE 5

O/W microemulsion

| | % by weight |
|---|---|
| Ceteareth-12 | 8.00 |
| Cetearyl isononanoate | 10.00 |
| Cetearyl alcohol | 4.00 |
| Eusolex ® 232 | 5.00 |
| Uvinul ® T 150 | 1.00 |
| Parsol ® 1789 | 4.00 |
| | pH = 7.5 |
| Dyestuffs, perfume, preservative | q.s. |
| Water | to 100.00 |

The UV filters are dissolved in the oily phase and combined with the other constituents of the oily phase, after which the mixture is homogenized, subsequently combined with the aqueous phase and brought to a temperature of 80-85° C. (i.e. into the phase inversion temperature range of the system), and the system is then cooled to room temperature (that is to say is brought out of the phase inversion temperature range of the system again).

### EXAMPLE 6

O/W/O emulsion

| | % by weight |
|---|---|
| Glyceryl isostearate | 4.00 |
| Cetearyl isononanoate | 20.00 |
| Stearic acid | 2.00 |
| Uvinul ® T 150 | 2.00 |
| Parsol ® 1789 | 3.00 |
| NaOH | to pH 7.0 |
| Dyestuffs, perfume, preservative | q.s. |
| Water | to 100.00 |

The UV filters are dissolved in the oily phase and combined with the remainder of the oily phase. Water is added and the system is heated to about 40° C. NaOH is added until a pH of 7 is reached, and the system is then cooled to room temperature.

### EXAMPLE 7

O/W microemulsion

| | % by weight |
|---|---|
| Ceteareth-12 | 8.00 |
| Cetearyl isononanoate | 10.00 |
| Mineral oil | 10.00 |
| Cetearyl alcohol | 4.00 |
| Uvinul ® T 150 | 2.00 |
| Parsol ® 1789 | 1.00 |
| Eusolex ® 6300 | 3.00 |
| TiO₂ | 4.80 |
| MgSO₄ | 3.00 |
| Dyestuffs, perfume, preservative | q.s. |
| Water | to 100.00 |

The inorganic micropigment and Uvinul® T 150 are presuspended in the mineral oil and combined with the remainder of the oily phase, after which the mixture is homogenized and then combined with the aqueous phase and brought to a temperature of 80-85° C. (i.e. into the phase inversion temperature range of the system), and the system is then cooled to room temperature (that is to say is brought out of the phase inversion temperature range of the system again).

### EXAMPLE 8

O/W microemulsion

| | % by weight |
|---|---|
| Ceteareth-12 | 12.00 |
| Cetearyl isononanoate | 10.00 |
| Mineral oil | 10.00 |
| Cetearyl alcohol | 6.00 |
| Uvinul ® T 150 | 2.00 |
| Parsol ® 1789 | 1.00 |
| TiO₂ | 4.80 |
| MgSO₄ | 3.00 |
| Dyestuffs, perfume, preservative | q.s. |
| Water | to 100.00 |

The inorganic micropigment and Uvinul® T 150 are presuspended in the mineral oil and combined with the remainder of the oily phase, after which the mixture is homogenized and then combined with the aqueous phase and brought to a temperature of 80-85° C. (i.e. into the phase inversion temperature range of the system), and the system is then cooled to room temperature (that is to say is brought out of the phase inversion temperature range of the system again).

### EXAMPLE 9

O/W microemulsion

| | % by weight |
|---|---|
| Ceteareth-12 | 8.00 |
| Cetearyl isononanoate | 10.00 |
| Mineral oil | 10.00 |
| Cetearyl alcohol | 4.00 |
| TiO₂ | 5.00 |
| MgSO₄ | 3.00 |
| Dyestuffs, perfume, preservative | q.s. |
| Water | to 100.00 |

The inorganic micropigment is presuspended in the mineral oil and combined with the remainder of the oily phase, after which the mixture is homogenized and then combined with the aqueous phase and brought to a temperature of 80-85° C. (i.e. into the phase inversion temperature range of the system), and the system is then cooled to room temperature (that is to say is brought out of the phase inversion temperature range of the system again).

### EXAMPLE 10

O/W/O emulsion

| | % by weight |
|---|---|
| Glyceryl isostearate | 5.00 |
| Mineral oil | 25.00 |
| Stearic acid | 2.00 |
| TiO₂ | 2.00 |
| NaOH | to pH 7.0 |
| Dyestuffs, perfume, preservative | q.s. |
| Water | to 100.00 |

The inorganic micropigment is dispersed in the oily phase. Water is added and the system is heated to about 40° C. NaOH is added until a pH of 7 is reached, and the system is then cooled to room temperature.

### EXAMPLE 11

O/W/O emulsion

| | % by weight |
|---|---|
| Polyglyceryl 2-polyhydroxystearate | 7.00 |
| Cetearyl isononanoate | 12.50 |
| Mineral oil | 12.50 |
| Stearic acid | 2.00 |
| TiO₂ | 2.00 |
| NaOH | to pH 7.0 |
| Dyestuffs, perfume, preservative | q.s. |
| Water | to 100.00 |

The inorganic micropigment is presuspended in the mineral oil and combined with the remainder of the oily phase. Water is added and the system is heated to about 40° C. NaOH is added until a pH of 7 is reached, and the system is then cooled to room temperature.

### EXAMPLE 12

O/W/O emulsion

| | % by weight |
|---|---|
| Polyglyceryl 2-polyhydroxystearate | 5.00 |
| Cetearyl isononanoate | 12.50 |
| Mineral oil | 12.50 |
| Stearic acid | 2.00 |
| TiO₂ | 2.00 |
| NaOH | to pH 7.0 |
| Dyestuffs, perfume, preservative | q.s. |
| Water | to 100.00 |

The inorganic micropigment is dispersed in the oily phase. Water is added and the system is heated to about 40° C. NaOH is added until a pH of 7 is reached, and the system is then cooled to room temperature.

### EXAMPLE 13

O/W microemulsion

| | % by weight |
|---|---|
| Polyglyceryl 2-polyhydroxystearate | 2.00 |
| Cetearyl isononanoate | 12.50 |
| Mineral oil | 12.50 |
| Stearic acid | 2.00 |
| TiO₂ | 2.00 |
| NaOH | to pH 7.0 |
| Dyestuffs, perfume, preservative | q.s. |
| Water | to 100.00 |

The inorganic micropigment is presuspended in the mineral oil and combined with the remainder of the oily phase. Water is added and the system is heated to about 40° C. NaOH is added until a pH of 7 is reached, and the system is then cooled to room temperature.

### EXAMPLE 14

O/W microemulsion

| | % by weight |
|---|---|
| Ceteareth-12 | 8.00 |
| Cetearyl isononanoate | 20.00 |
| Cetearyl alcohol | 4.00 |
| Eusolex ® 232 | 4.80 |
| MgSO₄ | 3.00 |
| | pH = 5.0 |
| Dyestuffs, perfume, preservative | q.s. |
| Water | to 100.00 |

The constituents of the oily phase are combined and homogenized and then combined with the aqueous phase and brought to a temperature of 80-85° C. (i.e. into the phase inversion temperature range of the system), and the system is then cooled to room temperature (that is to say brought out of the phase inversion temperature range of the system again).

### EXAMPLE 15

O/W microemulsion

| | % by weight |
|---|---|
| Ceteareth-12 | 12.00 |
| Cetearyl isononanoate | 20.00 |
| Cetearyl alcohol | 6.00 |
| Eusolex ® 232 | 4.80 |
| Parsol ® 1789 | 2.00 |
| MgSO₄ | 3.00 |
| | pH = 5.0 |
| Dyestuffs, perfume, preservative | q.s. |
| Water | to 100.00 |

The constituents of the oily phase are combined and homogenized and then combined with the aqueous phase and brought to a temperature of 80-85° C. (i.e. into the phase inversion temperature range of the system), and the system is then cooled to room temperature (that is to say brought out of the phase inversion temperature range of the system again).

### EXAMPLE 16

O/W microemulsion

| | % by weight |
|---|---|
| Ceteareth-12 | 8.00 |
| Cetearyl isononanoate | 10.00 |
| Mineral oil | 10.00 |
| Cetearyl alcohol | 4.00 |
| Uvinul ® T 150 | 4.80 |
| MgSO₄ | 3.00 |
| Dyestuffs, perfume, preservative | q.s. |
| Water | to 100.00 |

The Uvinul® T 150 is presuspended in the mineral oil and combined with the remainder of the oily phase, after which this is homogenized and then combined with the aqueous phase and brought to a temperature of 80-85° C. (i.e. into the phase inversion temperature range of the system), and the system is then cooled to room temperature (that is to say brought out of the phase inversion temperature range of the system again).

### EXAMPLE 17

O/W microemulsion

| | % by weight |
|---|---|
| Ceteareth-12 | 12.00 |
| Cetearyl isononanoate | 10.00 |
| Mineral oil | 10.00 |
| Cetearyl alcohol | 6.00 |
| Eusolex ® 6300 | 2.00 |
| Parsol ® 1789 | 0.50 |
| Uvinul ® T 150 | 4.80 |
| MgSO₄ | 3.00 |
| Dyestuffs, perfume, preservative | q.s. |
| Water | to 100.00 |

The Uvinul® T 150 is presuspended in the mineral oil and combined with the remainder of the oily phase, after which this is homogenized and then combined with the aqueous phase and brought to a temperature of 80-85° C. (i.e. into the phase inversion temperature range of the system), and the system is then cooled to room temperature (that is to say brought out of the phase inversion temperature range of the system again).

### EXAMPLE 18

O/W microemulsion

% by weight

| | | |
|---|---|---|
| Ceteareth-12 | | 8.00 |
| Cetearyl isononanoate | | 10.00 |
| Cetearyl alcohol | | 4.00 |
| Eusolex ® 232 | | 5.00 |
| Uvinul ® T 150 | | 1.00 |
| MgSO₄ | | 3.00 |
| | pH = | 5.0 |

| | |
|---|---|
| Dyestuffs, perfume, preservative | q.s. |

| | | |
|---|---|---|
| Water | to | 100.00 |

The constituents of the oily phase are combined and homogenized and then combined with the aqueous phase and brought to a temperature of 80-85° C. (i.e. into the phase inversion temperature range of the system), and the system is then cooled to room temperature (that is to say brought out of the phase inversion temperature range of the system again).

### EXAMPLE 19

O/W microemulsion

% by weight

| | |
|---|---|
| Ceteareth-12 | 8.00 |
| Cetearyl isononanoate | 10.00 |
| Mineral oil | 10.00 |
| Cetearyl alcohol | 4.00 |
| Uvinul ® T 150 | 5.00 |
| MgSO₄ | 3.00 |

| | |
|---|---|
| Dyestuffs, perfume, preservative | q.s. |

| | | |
|---|---|---|
| Water | to | 100.00 |

The Uvinul® T 150 is presuspended in the mineral oil and combined with the remainder of the oily phase, after which this is homogenized and then combined with the aqueous phase and brought to a temperature of 80-85° C. (i.e. into the phase inversion temperature range of the system), and the system is then cooled to room temperature (that is to say brought out of the phase inversion temperature range of the system again).

### EXAMPLE 20

O/W/O emulsion

% by weight

| | | |
|---|---|---|
| Glyceryl isostearate | | 5.00 |
| Mineral oil | | 25.00 |
| Stearic acid | | 2.00 |
| Uvinul ® T 150 | | 2.00 |
| NaOH | to pH | 7.0 |

| | |
|---|---|
| Dyestuffs, perfume, preservative | q.s. |

| | | |
|---|---|---|
| Water | to | 100.00 |

The Uvinul® T 150 is dispersed in the oily phase. Water is added and the system is heated to about 40° C. NaOH is added until a pH of 7 is reached, and the system is then cooled to room temperature.

### EXAMPLE 21

O/W/O emulsion

% by weight

| | | |
|---|---|---|
| Polyglyceryl 2-polyhydroxystearate | | 7.00 |
| Cetearyl isononanoate | | 12.50 |
| Mineral oil | | 12.50 |
| Stearic acid | | 2.00 |
| Uvinul ® T 150 | | 2.00 |
| Parsol ® 1789 | | 2.00 |
| Eusolex ® 232 | | 2.00 |
| NaOH | to pH | 7.0 |

| | |
|---|---|
| Dyestuffs, perfume, preservative | q.s. |

| | | |
|---|---|---|
| Water | to | 100.00 |

The UV filter substances are presuspended in the mineral oil and combined with the remainder of the oily phase. Water is added and the system is heated to about 40° C. NaOH is added until a pH of 7 is reached, and the system is then cooled to room temperature.

### EXAMPLE 22

O/W/O emulsion

% by weight

| | | |
|---|---|---|
| Polyglyceryl 2-polyhydroxystearate | | 5.00 |
| Cetearyl isononanoate | | 12.50 |
| Mineral oil | | 12.50 |
| Stearic acid | | 2.00 |
| Eusolex ® 232 | | 2.00 |
| Uvinul ® T 150 | | 2.00 |
| Eusolex ® 6300 | | 2.00 |
| Parsol ® 1789 | | 1.00 |
| NaOH | to pH | 7.0 |

| | |
|---|---|
| Dyestuffs, perfume, preservative | q.s. |

| | | |
|---|---|---|
| Water | to | 100.00 |

The UV filter substances are dispersed in the oily phase. Water is added and the system is heated to about 40° C. NaOH is added until a pH of 7 is reached, and the system is then cooled to room temperature.

### EXAMPLE 23

O/W microemulsion

% by weight

| | | |
|---|---|---|
| Polyglyceryl 2-polyhydroxystearate | | 2.00 |
| Cetearyl isononanoate | | 12.50 |
| Mineral oil | | 12.50 |
| Stearic acid | | 2.00 |
| Uvinul ® T 150 | | 2.00 |
| NaOH | to pH | 7.0 |

| | |
|---|---|
| Dyestuffs, perfume, preservative | q.s. |

| | | |
|---|---|---|
| Water | to | 100.00 |

The Uvinul® T 150 is presuspended in the mineral oil and combined with the remainder of the oily phase. Water is added and the system is heated to about 40° C. NaOH is added until a pH of 7 is reached, and the system is then cooled to room temperature.

1. O/W emulsions, in particular O/W microemulsions, or O/W/O emulsions or O/W/O′ emulsions comprising
an aqueous phase,
if appropriate, customary water-soluble or -dispersible substances,
an oily phase,
at least one emulsifier (emulsifier A) chosen from the group of emulsifiers having the following properties
their lipophilicity either depends on the pH such that the lipophilicity is increased or decreased by raising or lowering the pH, it being unimportant which of the two possible changes in lipophilicity is effected by raising or lowering the pH, and/or
their lipophilicity depends on the temperature such that the lipophilicity increases with increasing temperature and their hydrophilicity, increases with decreasing temperature,
and furthermore, if appropriate, further substances which are soluble or dispersable in the oily phase, including, preferably, those chosen from the group of emulsifiers which do not fall under the definition of emulsifier A, in particular those which chiefly act as W/O emulsifiers.

2. Process for the preparation of O/W emulsions, in particular O/W microemulsions, or O/W/O emulsions or O/W/O′ emulsions, characterized in that an aqueous phase, if appropriate, customary a water-soluble or -dispersible substances, an oily phase and
at least one emulsifier (emulsifier A) chosen from the group of O/W emulsifiers having the following properties
their lipophilicity depends on the PH such that the lipophilicity is increased or decreased by raising or lowering the pH, it being unimportant which of the two possible changes in lipophilicity is effected by raising or lowering the pH, and
if appropriate, their lipophilicity additionally depends on the temperature such that the lipophilicity increases with increasing temperature and their hydrophilicity increases with decreasing temperature,
and furthermore, if appropriate, further substances which are soluble or dispersible in the oily phase, including, preferably, those chosen from the group of emulsifiers which do not fall under the definition of emulsifier A, are brought together and a mixture is formed, with agitation, such that
by suitable choice of the parameters chosen from the group consisting of pH, temperature and the concentration or concentrations of at least one of the emulsifiers chosen, this mixture is brought into the phase inversion range in which W/O emulsions are converted into O/W emulsions,
by varying at least one parameter chosen from the group consisting of pH, temperature and the concentration or concentrations of at least one of the emulsifiers chosen, the W/O emulsion formed is brought out of the phase inversion range in which a W/O emulsion formed is converted into an O/W emulsion, whereupon an O/W emulsion or O/W microemulsion is produced,
if appropriate, by suitable choice of the framework conditions, another phase inversion to give an O/W/O emulsion is initiated,
if appropriate, the mixture is subjected to further processing steps, in particular one or more homogenizing steps.

3. Process according to claim 2 for the preparation of O/W/O emulsions, characterized in that the oily phase content is greater than about 15% by weight, in particular greater than about 20% by weight, based on the total weight of the formulation, more than about 5% by weight, in particular about 5-10% by weight, of an additional emulsifier which acts as a W/O emulsifier at room temperature is present, and/or the oily phase has a low content of polar oils or is essentially free from such oils.

4. Process according to claim 2 for the preparation of O/W microemulsions, characterized in that the oily phase content is less than about 20% by weight, in particular less than about 15% by weight, based on the total weight of the formulation, less than about 5% by weight of an additional emulsifier which acts as a W/O emulsifier at room temperature is present, and/or the oily phase has a high content of polar oils.

5. O/W/O emulsions or O/W microemulsions according to claim 1, characterized in that emulsifier A is chosen from the group consisting of sorbitan esters and sucrose esters, in particular of branched and unbranched alkyl esters and alkenyl esters having carbon chains of 4-24 carbon atoms, preferably sorbitan stearate, sorbitan oleate, glycerylsorbitan stearate, sucrose monostearate, sucrose monolaurate and sucrose palmitate, of monoglycerol monocarboxylic acid monoesters and of di- and triglycerol monocarboxylic acid monoesters, and furthermore triglyceryl diisostearate, isostearyldiglyceryl succinate, diglyceryl sesquiisostearate, triglyceryl polyhydroxystearate, cetearyl isononanoate and dicocoyl-pentaerythrityldistearyl citrate, and furthermore the methicone copolyols, cyclomethicone copolyols, alkylmethicone copolyols, laurylmethicone copolyol and cetyldimethicone copolyol, as well as from the group consisting of branched or unbranched alkylmonocarboxylic acids, alkenylmonocarboxylic acids and alkylenedicarboxylic acids having 4 to 30 carbon atoms, in particular stearic acid, oleic acid, succinic acid, hexanoic acid (caproic acid), heptanoic acid (oenanthic acid), octanoic acid (caprylic acid), nonanoic acid (pelargonic acid), decanoic acid (capric acid), undecanoic acid, undecenoic acid (undecylenic acid), dodecanoic acid (lauric acid), tridecanoic acid, tetradecanoic acid (myristic acid), pentadecanoic acid, hexadecanoic acid (palmitic acid), heptadecanoic acid (margaric acid), octadecanoic acid (stearic acid), isostearic acid and behenic acid and cosmetically or pharmaceutically acceptable salts thereof, in particular of the alkali metal, ammonium, monoalkylammonium, dialkylammonium, trialkylammonium and tetraalkylammonium salts.

6. O/W/O emulsions or O/W microemulsions according to claim 1, characterized in that the emulsifier A or emulsifiers A is or are present in concentrations of 0.01-20% by weight, preferably 0.05-10% by weight, particularly preferably 0.1-5% by weight, in each case based on the total weight of the composition.
